(19) United States
(12) Patent Application Publication
(10) Pub. No.: US 2026/0229141 A1
(43) Pub. Date: Aug. 6, 2026

(54) Music Theory Learning Device

(71) Applicant: David Farrell Melton, Maplewood, NJ (US)

(72) Inventor: David Farrell Melton, Maplewood, NJ (US)

(21) Appl. No.: 19/151,243

(22) PCT Filed: Jan. 25, 2024
(86) PCT No.: PCT/US24/13002

§ 371 Date: Jul. 25, 2025

Related U.S. Application Data
(63) Continuation-in-part of application No. 29/935,197, filed on Mar. 29, 2024, now Pat. No. D1126293.
(60) Provisional application No. 63/481,734, filed on Jan. 26, 2023.

(51) Int. Cl. G09B 15/00; G10G 1/00

(52) U.S. Cl. CPC G09B 15/007; G10G 1/00

(57) ABSTRACT

The music theory learning device is a teaching aid for learning music theory that includes a plurality of disks (wheels) arranged on two sides. Side 1 is organized using the circle of 5ths (intervals of 5ths) and side 2 is organized using the chromatic scale (intervals of half-steps). Two inner wheels that are centrally positioned on each side over the outer wheel includes a plurality of numbers. The device is designed to be used in conjunction with an instruction booklet that includes table diagrams. The table diagrams show unique formulas for various intervals, scales, chords, and modes. In addition, the user can also use the device to transpose a written song, such that it is written in a different key. Thus, the device may be used in different ways to improve the user's understanding of music theory, as well as to provide a more enjoyable experience while playing an instrument.

### FIELD OF THE INVENTION

The present invention relates generally to a music learning aid. More specifically, the present invention is a music wheel designed to assist musicians in learning and using music theory.

### BACKGROUND OF THE INVENTION

Music theory is the study of the practices and possibilities of music. It encompasses the methods and concepts that composers use in creating music. Learning the fundamental concepts of music theory is also beneficial for beginner musicians of all ages who are learning to play a new instrument. One of the challenges for any beginner musician is the ability to acquire knowledge of the basic key structure and chord structure for the instrument. Since keys can be arranged in a variety of scales and chords, having a better understanding of music theory can enhance the musician's skills and increase the level of enjoyment of playing the instrument. Later on, as the musician becomes more experienced, he or she can experiment with the variations and subtleties of changing the chords in several ways, thereby blending melody and harmony.

However, when learning a new instrument, it can be very difficult for a beginner musician (beginner) to determine the correct notes of a certain type of scale in a certain key. This is due to the fact that most beginners have trouble grasping the fundamental concepts behind the organization of musical scale structures. Learning these fundamental concepts can become tiresome and frustrating for beginners. There are several types of musical aids (charts, tables, and graphs) designed to help beginners understand music theory, but these aids have limited effectiveness. In particular, beginners become easily confused by the overwhelming array of letters and symbols displayed on the aids. In addition, these aids generally require that the beginner already possess a detailed understanding of music theory. As such, a need exists to develop a music learning aid designed to teach the fundamentals of music theory in order to determine the proper chords, scales, keys, and notes for various musical works.

An objective of the present invention is to provide a solution to the aforementioned problems. More specifically, it is an aim of the present invention to provide a teaching aid for learning music theory. The present invention is a Music Wheel comprising multiple disks (wheels), marked “Side 1” and “Side 2”. The Music Wheel is designed to teach the user of any instrument how to spell the intervals, chords, scales, and modes that are the foundation of every song in Western music. The present invention provides a concise and comprehensive method of learning how to read chord changes and transpose chord progressions. Since nearly all songs are derived from the same 12 notes, using the present invention enables the user to easily identify the tonal center of every song and all the relative positions that the remaining 11 notes take on. Understanding the relationship between these 12 notes is the study of music theory, and the present invention is the ultimate visual aid.

### SUMMARY OF THE INVENTION

It is an aim of the present invention to provide a teaching aid for learning music theory. The present invention comprises a plurality of disks (wheels), each marked “Side 1” and “Side 2”. Side 1 is organized using the circle of 5ths (intervals of 5ths) and Side 2 is organized using the chromatic scale (intervals of half-steps). These are the only two ways to organize the 12 notes of Western Music in equal intervals. Regardless of which side the user chooses, both sides are configured to produce the same result. In particular, the outer wheel comprises 12 notes positioned along the outer perimeter of each side.

Above each of the 12 notes are the corresponding key signatures. The key signature designates which notes are sharp or flat relative to the tonal center. The inner wheel is centrally positioned over the outer wheel and comprises a plurality of numbers on each side. The tonal center is represented by the “1” on both sides. When the inner wheel is properly attached, (aligned) the other 11 notes on the outer wheel that surround the tonal center take on their relative numerical positions.

The present invention is designed to be used in conjunction with the included table diagrams. The table diagrams show unique formulas for various intervals, scales, chords, and modes. For example, the user can spin the wheel and spell out a certain type of chord shown in the chord table. In addition, the user can also use the present invention to transpose a written song, such that it is written in a different key. Thus, the present invention can be used in a variety of ways to improve the user's understanding of music theory, as well as providing a more enjoyable experience while playing an instrument.

### BRIEF DESCRIPTION OF THE DRAWINGS

FIG. 1 is a plan view of Side 1 of the present invention.

FIG. 2 is a plan view of Side 2 of the present invention.

FIG. 3 is a plan view of Side 1 of the present invention, showing only the outer wheel.

FIG. 4 is a plan view of Side 1 of the present invention, showing only the inner wheel.

FIG. 5 is a is a top-front perspective exploded view of the present invention.

FIG. 6 is a front plan view an instructional booklet with the content on a page of the booklet is illustrated, wherein the content is a diagram map, showing the arrangement of musical notes on a keyboard.

FIG. 7 is a table diagram of the present invention, showing formulas for various intervals.

FIG. 8 is a table diagram of the present invention, showing formulas for various scales.

FIG. 9 is a table diagram of the present invention, showing formulas for various chords.

FIG. 10 is a table diagram of the present invention, showing formulas for various chord extensions.

FIG. 11 is a table diagram of the present invention, showing formulas for various modes.

FIG. 12 is a is a table diagram of the present invention, showing various chord symbols.

FIG. 13 is a plan view of Side 1 and Side 2 of the present invention, illustrating an example for spelling a perfect 4^{th} in the key of C.

FIG. 14 is a plan view of Side 1 and Side 2 of the present invention, illustrating an example for spelling a G Minor Triad.

FIG. 15 is a plan view of Side 1 and Side 2 of the present invention, illustrating an example for spelling a D Dominant Seventh Sharp Eleven.

FIG. 16 depicts a bar of music written in general form of music notation.

FIG. 17 depicts a bar of music written in alternative form outlined in FIG. 16, illustrating an example of transposition.

### DETAIL DESCRIPTIONS OF THE INVENTION

All illustrations of the drawings are for the purpose of describing selected versions of the present invention and are not intended to limit the scope of the present invention.

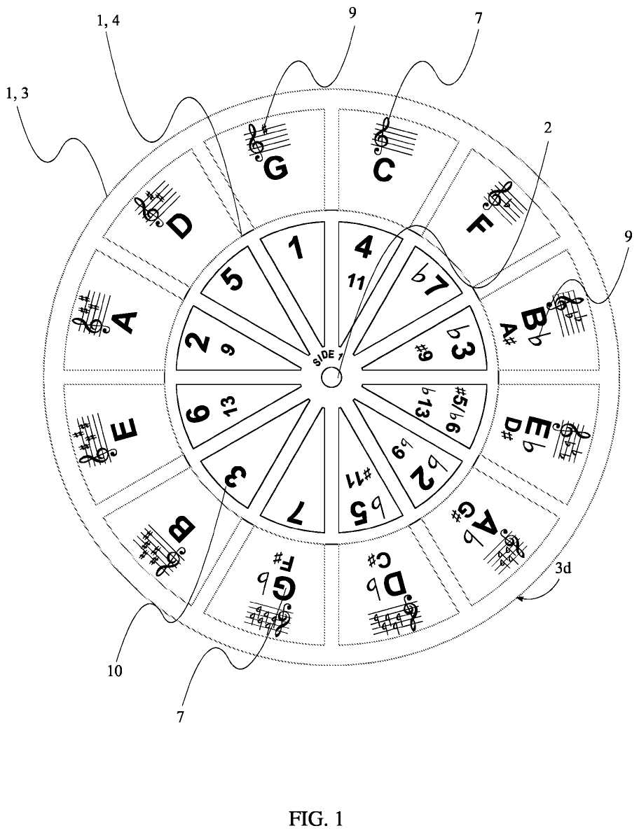

In reference to FIG. 1 through FIG. 17, the present invention is a music learning aid designed to teach the user of any instrument how to spell the intervals, chords, scales, and modes that are the foundation of every song in Western music. More specifically, the present invention provides a concise and comprehensive method of learning how to read chord changes and transpose chord progressions.

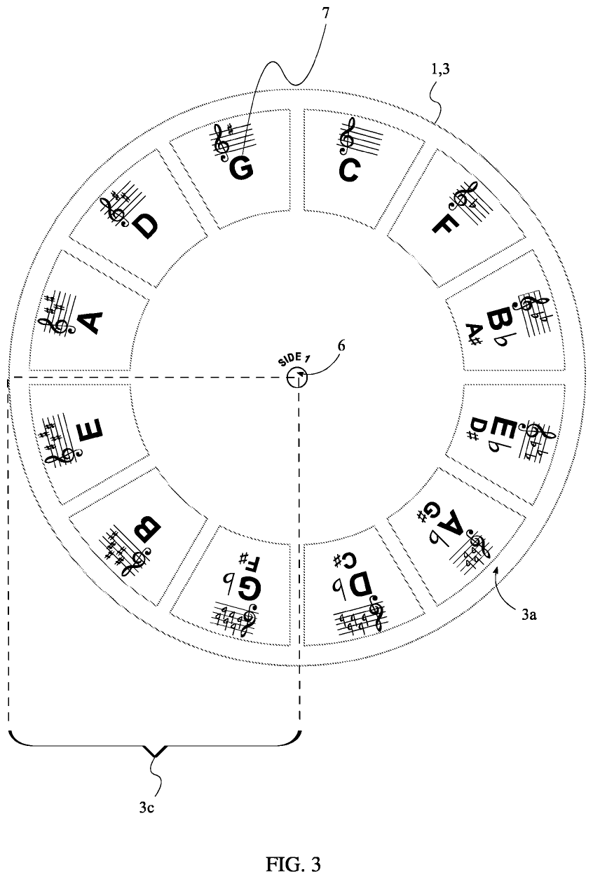

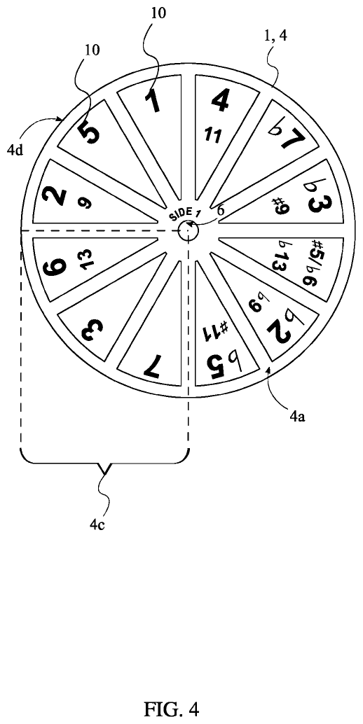

The following description is in reference to FIG. 1 through FIG. 17. According to a preferred embodiment, the present invention comprises a plurality of discs 1, and at least one fastener 2. The plurality of discs 1 may be formed of paper, laminated paper, cardboard, or any other suitable material based on design, user, and/or manufacturing requirements. In the preferred embodiment, the plurality of discs 1 comprises a first disc 3, a second disc 4, and a third disc 5. Preferably, the first disc 3 comprises a first surface 3a and a second surface 3b wherein the first surface 3a is positioned opposite to the second surface 3b across the first disc 3. In other words, the first surface 3a constitutes a first side of the first disc 3 and the second surface 3b constitutes a second side that is opposite to the first side. Further, the second disc 4 comprises a third surface 4a and a fourth surface 4b, wherein the third surface 4a is positioned opposite to the fourth surface 4b across the second disc 4. Similarly, the third disc 5 comprises a fifth surface 5a and a sixth surface 5b, wherein the fifth surface 5a is positioned opposite to the sixth surface 5b across the third disc 5. As seen in FIG. 3 and FIG. 4, the second disc 4 and the third disc 5 constitute two inner wheels and the first disc 3 constitutes the one outer wheel of the present invention. To that end, the second disc 4 is mounted adjacent to the first disc 3, wherein the fourth surface 4b is oriented towards the first surface 3a, and the third disc 5 is mounted adjacent to the first disc 3, wherein the sixth surface 5b is oriented towards the second surface 3b. In other words, the second disc 4 is mounted on top of the first surface 3a of the first disc 3, and the third disc 5 is mounted on top of the second surface 3b of the first disc 3. More specifically, the second disc 4 is positioned opposite to the third disc 5 across the first disc 3.

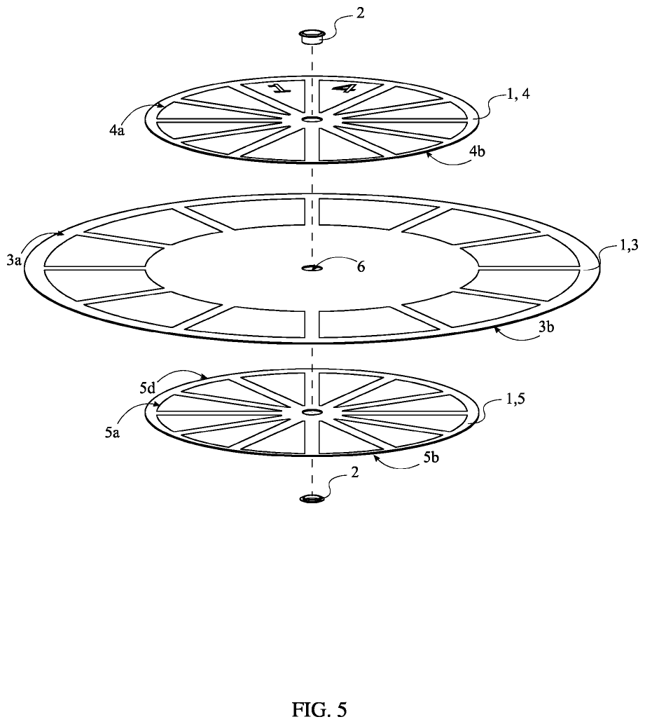

In order to securely fasten and connect the plurality of discs, the fastener 2 is axially integrated between the plurality of discs 1. As seen in FIG. 4, the plurality of discs 1 is concentrically connected to each other through the fastener 2. As seen in FIG. 3 through FIG. 5, the present invention comprises a central hole 6, wherein the central hole 6 traverses concentrically through the plurality of discs 1. Preferably, the fastener 2 is mounted within the central hole 6. Furthermore, the second disc 4 and the third disc 5 are rotatably connected about the first disc 3. In other words, all three wheels are rotatably mounted with respect to each other at the central hub through the fastener 2, as seen in FIG. 5. In the preferred embodiment, the fastener 2 is a rivet. However, it should be noted that the fastener 2 can be in the form of a brad, stud, or any other rotatable connector mechanism that functions as a pivot point, as long as the intents of the present invention are not altered.

In the preferred embodiment, the third surface 4a of the second disc 4 along with the first surface 3a of the first disc 3 constitutes a “Side 1” of the device, and the fifth surface 5a of the third disc 5 along with the second surface 3b of the first disc 3 constitutes a “Side 2” of the device. Thus, when fully attached, the user can use either “Side 1” or “Side 2”. Both sides are configured to produce the same result.

Continuing with the preferred embodiment, the first disc 3 comprises a first radius 3c, the second disc 4 comprises a second radius 4c, and the third disc 5 comprises a third radius 5c. As seen in FIG. 1 through FIG. 5, the first radius 3c is greater than the second radius 4c, the first radius 3c is greater than the third radius 5c, and the second radius 4c is equal to the third radius 5c. This arrangement enables the present invention, easy visual appeal, easy alignment, symmetry, and thus aesthetic appeal.

Before describing a present invention and how it can be used, it is first necessary to discuss a few fundamental musical principles. An “Interval” is the distance between two notes. Intervals are measured using Half-Steps. A “Half-Step” is the smallest interval in traditional western music. A “sharp” (#) means to go up one Half-Step, whereas a “flat” (♭) means to go down one Half-Step. Music is a universal language and like any language, music has its own alphabet. Instead of 26 letters, there are 12 notes (A, B, C, D, E, F, G, C^{#}/D ♭, D^{#}/E ♭, F^{#}/G ♭, G^{#}/A ♭, A^{#}/B ♭). Understanding the relationship between these 12 notes is the study of music theory.

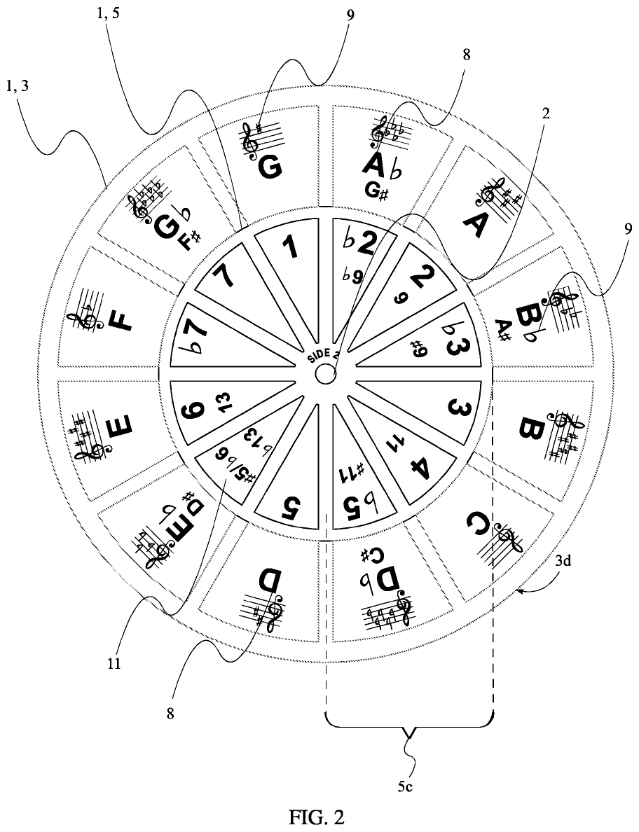

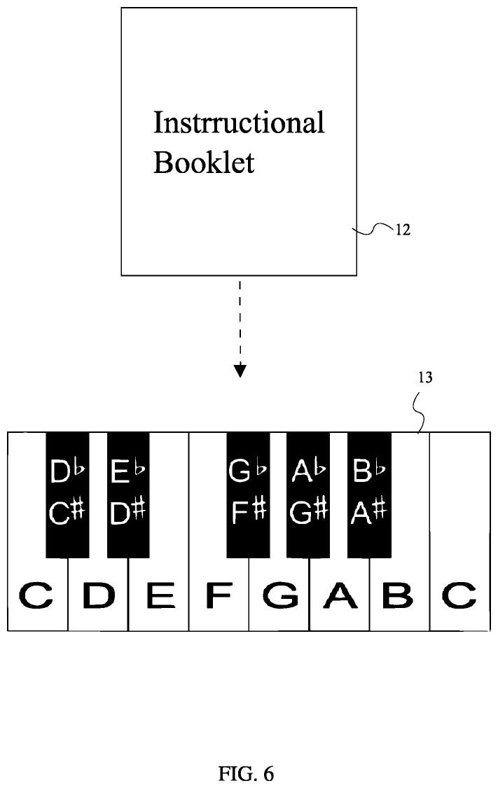

As can be seen in FIG. 6, the 12 notes are arranged on a keyboard. Accordingly, these 12 notes are positioned along the outer perimeter of “Side 1” and “Side 2” of the outer wheel, as shown in FIG. 1 and FIG. 2. Almost every melody for every song in the history of Western music is derived from these same 12 notes. And every melody has a “root” or “tonal center.” The “tonal center” is the central note around which all other notes revolve. The tonal center is represented by the “1” in the inner wheel (second disc and third disc) on both “Side 1” and “Side 2.” As illustrated in FIG. 1 and FIG. 2, once the tonal center is identified, all the other 11 notes take on their relative numerical positions. Every tonal center also has its own unique “key signature.” The key signature designates which notes are sharp or flat relative to the tonal center.

Continuing with the preferred embodiment, the present invention comprises a first set of musical notations 7, and a second set of musical notations 8. Preferably, the first set of musical notations 7 is perimetrically arranged on the first surface 3a, adjacent to a first terminal edge 3d of the first disc 3. In the preferred embodiment, the first set of musical notations 7 comprises the circle of 5ths (intervals of 5ths). Further, the second set of musical notations 8 is perimetrically arranged on the second surface 3b, adjacent to the first terminal edge 3d of the first disc. In the preferred embodiment, the second set of musical notations 8 comprises the chromatic scale (intervals of half-steps). The first set of musical notations 7 and the second set of musical notations 8 are the only two ways to organize the 12 notes of Western Music in equal intervals. Regardless of which side the user chooses, both sides are configured to produce the same result. In particular, the first disc 3 comprises 12 notes positioned along the outer perimeter of each side. Above each of the 12 notes are the corresponding key signatures. Accordingly, the present invention comprises a plurality of key signatures 9, wherein the plurality of key signatures 9 are distributed adjacent to the first set of musical notations 7, and the second set of musical notations 8. The key signature designates which notes are sharp or flat relative to the tonal center. In the preferred embodiment, the first set of musical notations 7, the second set of musical notations 8 and the plurality of key signatures 9 are printed on the plurality of discs 1. However, any other method of arrangement such as embossing, writing, sticking with adhesives, etc. may be employed to display the characters on the plurality of discs 1.

Continuing with the preferred embodiment, the present invention comprises a first set of numbers 10, wherein the first set of numbers 10 is arranged radially on the third surface 4a of the second disc 4, adjacent to a second terminal edge 4d of the second disc 4. As seen in FIG. 1, the first set of musical notations 7 is laterally offset from the first set of numbers 10, and each of the numbers from the first set of numbers 10 is linearly aligned to each of the notations from the first set of musical notations 7. Similarly, the present invention comprises a second set of numbers 11, wherein the second set of numbers 11 is arranged radially on the fifth surface 5a of the third disc 5, adjacent to a third terminal edge 5d of the third disc 5. Preferably, the second set of musical notations 8 is laterally offset from the second set of numbers 11, and each of the numbers from the second set of numbers 11 is linearly aligned to each of the notations from the second set of musical notations 8. In other words, the inner wheel is centrally positioned over the outer wheel and comprises a plurality of numbers on each side. The tonal center is represented by the “1” on both sides. When the inner wheel is properly attached, (aligned) the other 11 notes on the outer wheel that surround the tonal center take on their relative numerical positions.

According to the preferred embodiment, the present invention comprises an instructional booklet 12, wherein the instructional booklet 12 comprises a plurality of formulas and tables 13. The present invention is designed to be used in conjunction with the included table diagrams. The table diagrams show unique formulas for various intervals, scales, chords, and modes. In other words, each of the plurality of formulas and tables 13 comprises at least one of chords, scales, intervals, modes, chord extensions, and chord symbols related to music. For example, the user can spin the wheel and spell out a certain type of chord shown in the chord table. In addition, the user can also use the present invention to transpose a written song, such that it is written in a different key.

Thus, the present invention can be used in a variety of ways to improve the user's understanding of music theory, as well as providing a more enjoyable experience while playing an instrument.

For most songs, while the tonal center may never change, with each melodic phrase comes a progression of relative chords and scales. A “chord” is usually three or more tones played simultaneously, while a “scale” is a series of tones (usually five to seven) that ascend and/or descend. Thus, the present invention enables the user to spell every interval, chord, and scale by simply spinning the wheel. Furthermore, the instructional booklet 12 comprises a section on introduction to music theory.

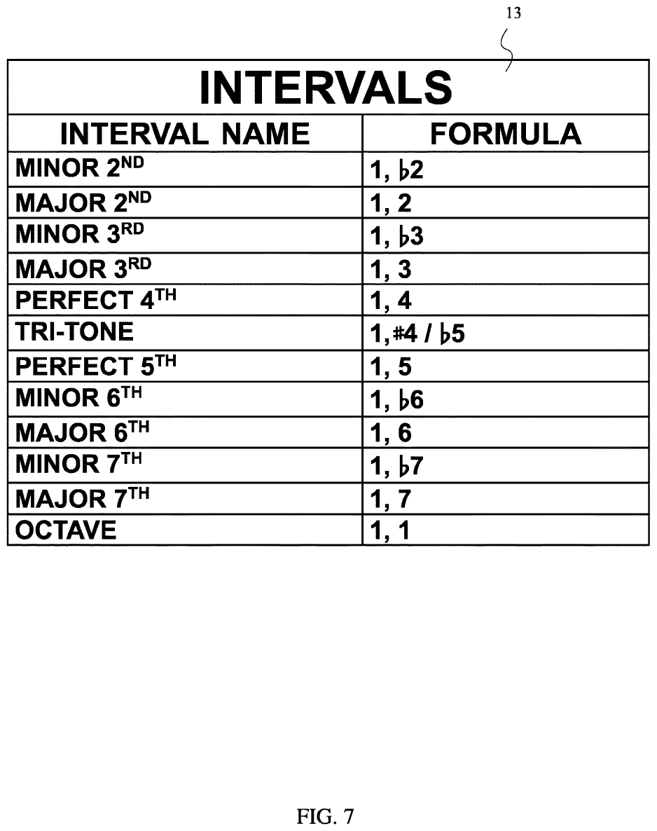

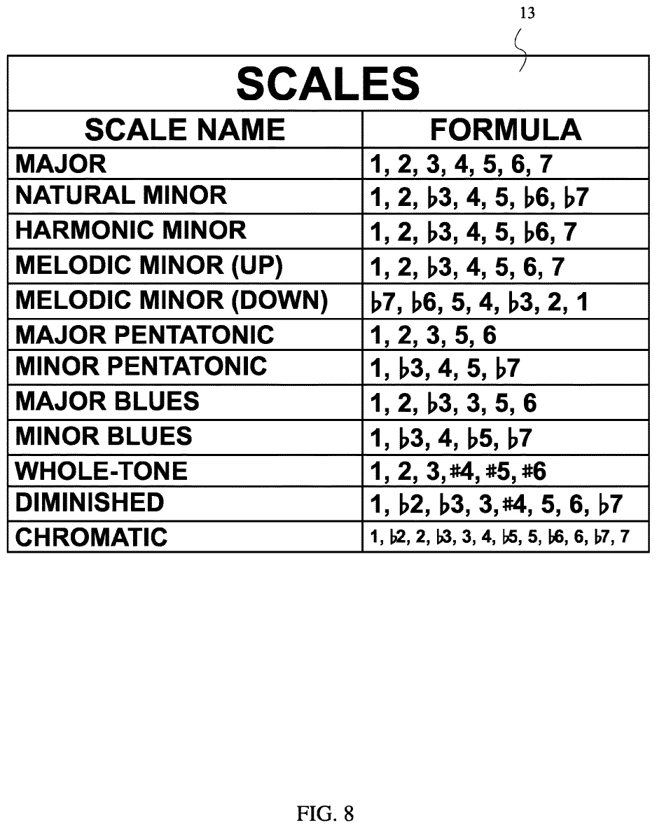

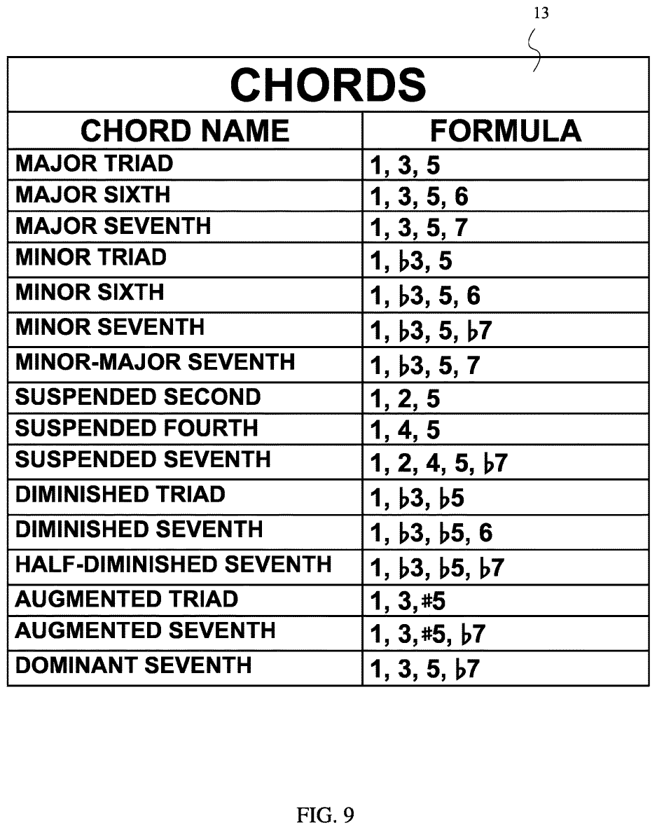

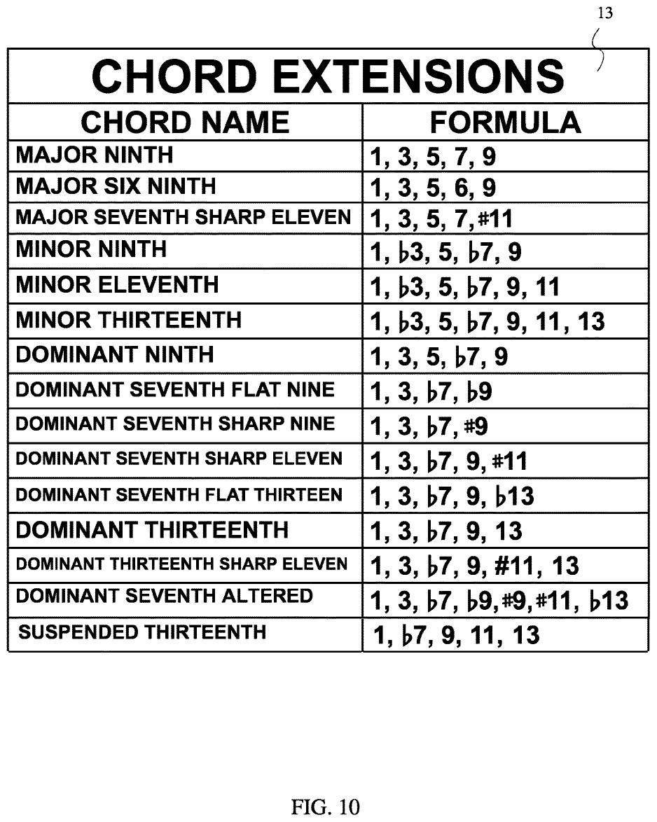

Music theory operates in such a way that each interval, chord, and scale has its own unique formula. Regardless of whether the user is playing the trumpet, saxophone, piano, violin, or guitar, the same theory applies to all instruments in western music that use these 12 notes. The unique formulas are provided in table format as shown in FIGS. 7-11. While there may be endless combinations of chords and scales, the ones shown throughout FIGS. 7-11 are the most common that make up the majority of the music you hear. Specifically, FIG. 7 provides formulas for different types of intervals. FIG. 8 provides formulas for different types of scales. FIG. 9 provides formulas for different types of chords. FIG. 10 provides formulas for different types of chord extensions.

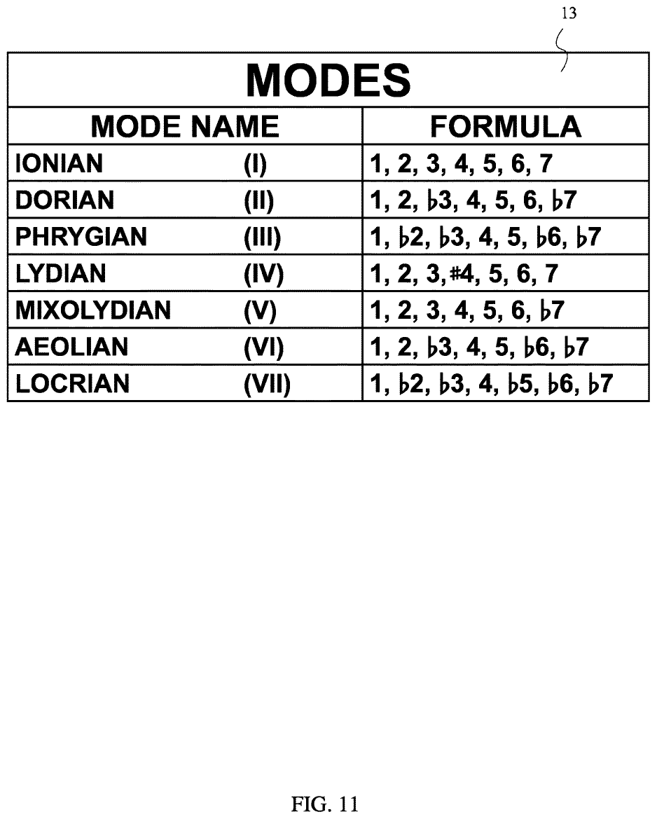

Lastly, FIG. 11 provides formulas for different types of modes.

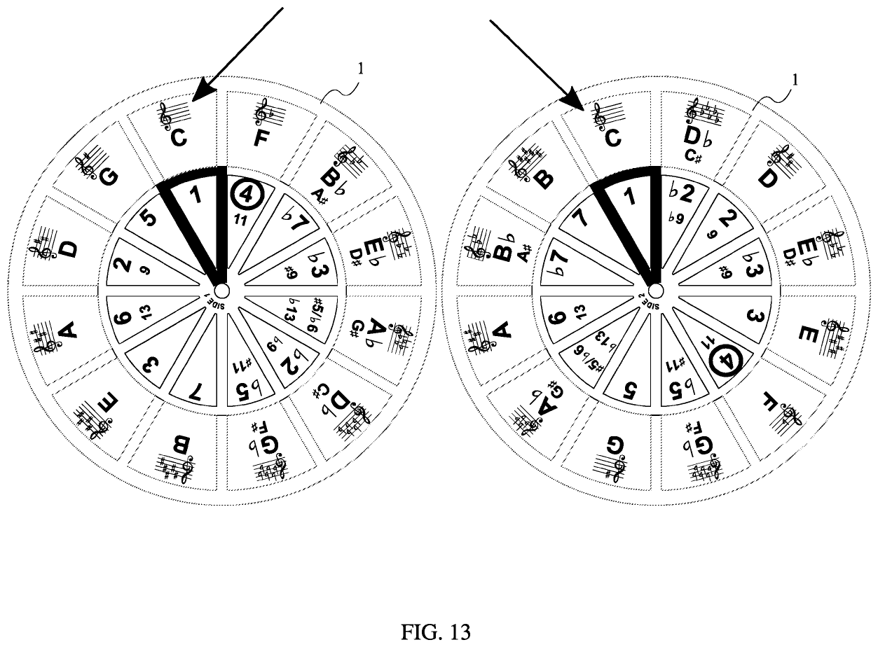

For a better understanding of how to use the present invention, the following example describes the steps used to spell a perfect 4^{th} in the key of C. As seen in FIG. 13, the user first lines up the “1” of the inner wheel with the tonal center of the outer wheel, which in this case is “C.” Referring back to the Intervals Table in FIG. 7, the formula for a perfect 4^{th} is [1,4]. Using the present invention, it is understood that “1” corresponds with “C” and “4” corresponds with “F.” Therefore, the distance between a C up to an F is a perfect 4^{th}. Meanwhile, it's important to emphasize that the distance from a C down to an F is not a perfect 4^{th}. Using the present invention, the user always measures intervals moving upwards.

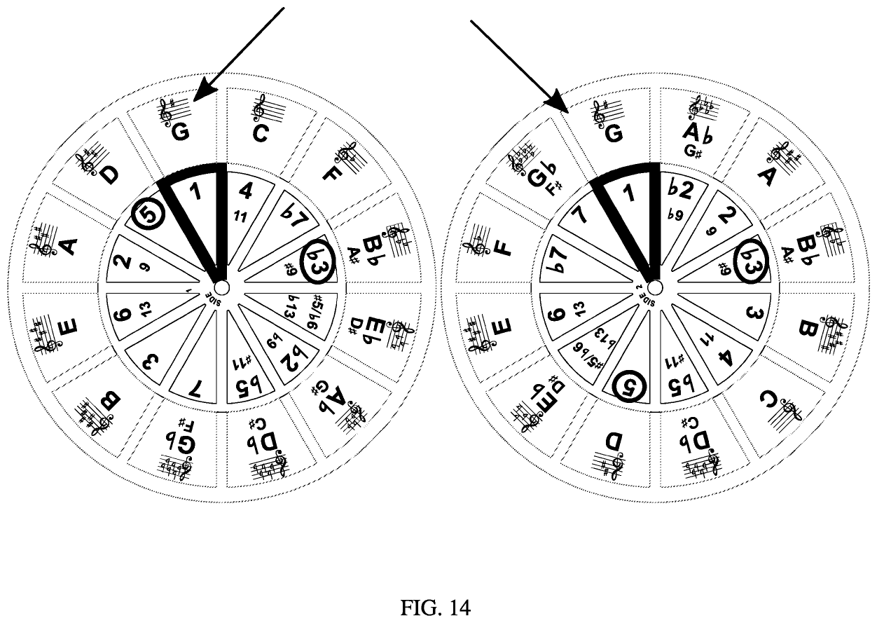

The following example describes the steps used to spell a G Minor Triad. As seen in FIG. 14, the user first lines up the “1” of the inner wheel with the tonal center of the outer wheel, which in this case is “G.” Referring back to the Chords Table in FIG. 9, the formula for minor triad is [1,♭3, 5]. Using the present invention, it is understood that “1” corresponds with “G”, “♭3” corresponds with “B♭”, and “5” corresponds with “D.” Regardless of what notes are on top or on bottom, these three notes played at once will always spell a G minor triad. Also, because the formula for a minor triad has a ♭3, the corresponding note B♭ is used instead of A^{#} even though technically it is the same note. Like every language, music has its own rules for grammar and some of these rules can be a little strange.

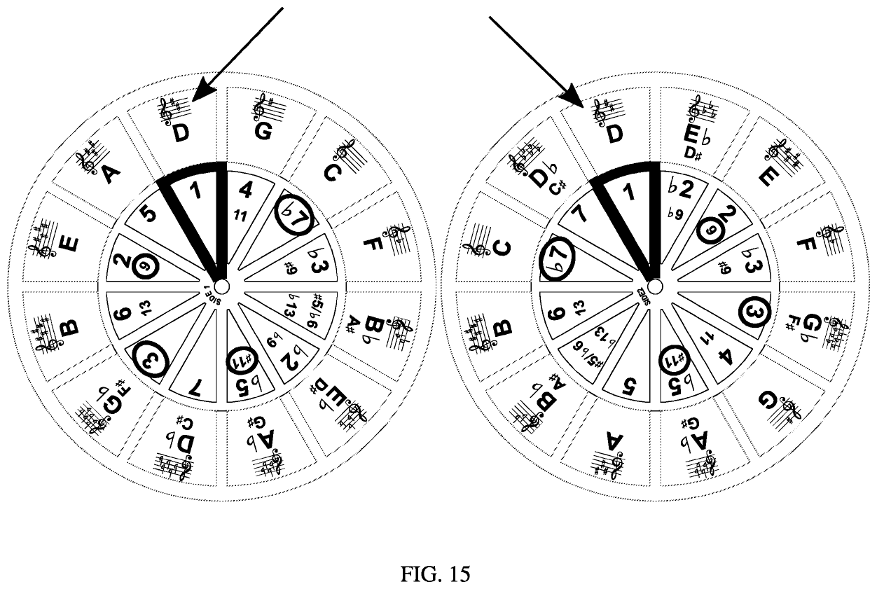

The following example describes the steps used to spell a D Dominant Seventh Sharp Eleven. As seen in FIG. 15, the user first lines up the “1” of the inner wheel with the tonal center of the outer wheel, which in this case is “D.” Referring back to the Chord Extensions Table in FIG. 10, the formula for a Dominant Seventh Sharp Eleven is [1, 3,♭7, 9,^{#}11]. Using the present invention, it is understood that “1” corresponds with “D”, “3” corresponds with “F^{#}”, “♭7” corresponds with “C”, “9” corresponds with “E”, and “^{#}11” corresponds with “G^{#}.” Therefore, these five notes spell a D Dominant Seventh Sharp Eleven. Looking at the key signature for the key of “D”, there are two sharps and zero flats. For this reason, sharps are used when spelling the scale instead of flats. As previously explained, the corresponding note F^{#} is used instead of G♭, even though technically it is the same note.

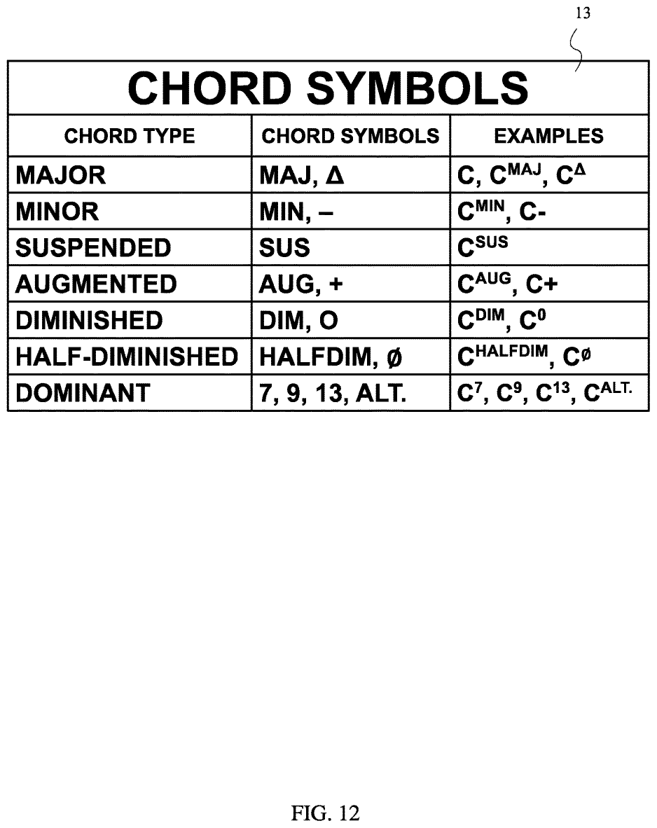

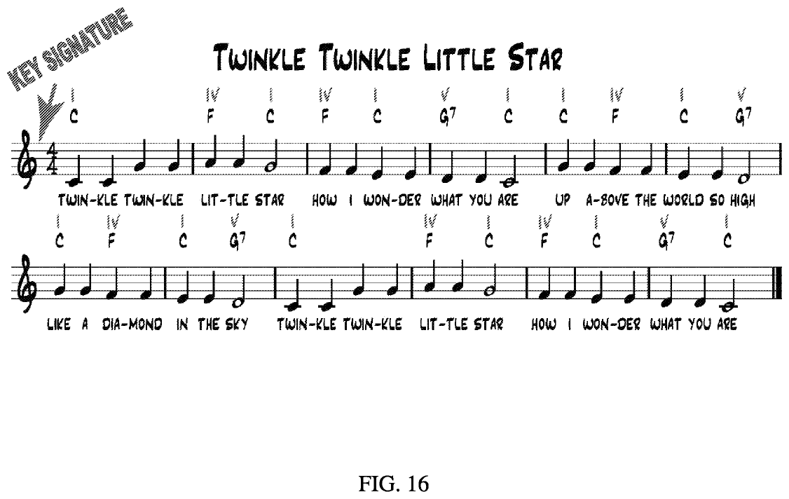

As can be seen in FIG. 16, the melody to the popular song “Twinkle Twinkle Little Star” is shown. Most popular music is written similarly to what is shown in FIG. 16. In particular, the melody is written out on the music staff along with the accompanying chords. Even for users who do not know how to read music, the chords and words are arranged in such a manner so that any user can still see what chords to play and when the chords line up with the words. For reference, a description of the various chord symbols is described in FIG. 12. If a chord does not have a symbol to show its quality (e.g., major, minor, diminished), it is implied that the chord is a major triad. Also, if there is no chord marking above a melody note, the user plays the previously played chord. In addition to the chord symbols in FIG. 12, a user may notice the use of “Slash Chords.” Slash Chords are written using a forward slash (/) and we play the chord written to the left of the slash with the note written to the right of the slash as the bottom note. For example, one might see a “B♭7/D” in which case the user would play a “B♭” dominant seventh chord with a “D” as the bottom note. There are endless combinations of slash chords. By using the present invention, the user can spend time exploring which chords the user likes most.

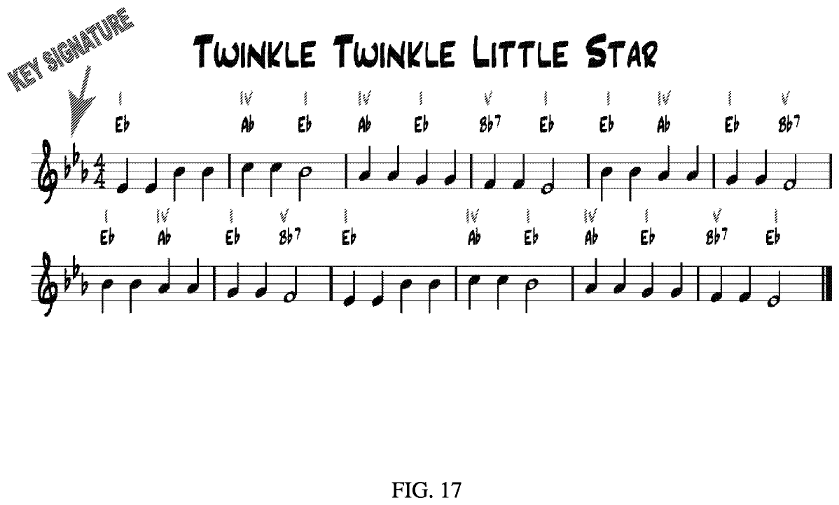

Having established a general understanding of chord structure, the following steps illustrate how the present invention can be used for transposing a melody. The song in FIG. 16 is in the key of “C”, whereas the song in “FIG. 17 is in the key of “E♭”, a minor third up from “C”. This is known as transposition. Transposing a song is to change the tonal center. This method is useful when a singer wants to move the song up or down, depending on the register of their voice. Any song can be played in all 12 keys. Using the invention, we can easily reorient the tonal center of a song to see all the relative numerical positions of the other 11 notes. In this case we could move the “1” from “C” to “Eb.” Thus, the present invention can be used to transpose any written song, thereby allowing the user to play the same song but in a different key.

Although the invention has been explained in relation to its preferred embodiment, it is to be understood that many other possible modifications and variations can be made without departing from the spirit and scope of the invention as hereinafter claimed.

What is claimed is:

1. A music theory learning device comprising:
a plurality of discs;
at least one fastener;
the plurality of discs comprising a first disc, a second disc, and a third disc;
the first disc comprising a first surface and a second surface wherein the first surface is positioned opposite to the second surface across the first disc;
the second disc comprising a third surface and a fourth surface, wherein the third surface is positioned opposite to the fourth surface across the second disc;
the third disc comprising a fifth surface and a sixth surface, wherein the fifth surface is positioned opposite to the sixth surface across the third disc;
the second disc being mounted adjacent to the first disc, wherein the fourth surface is oriented towards the first surface;
the third disc being mounted adjacent to the first disc, wherein the sixth surface is oriented towards the second surface;
the fastener being axially integrated between the plurality of discs;
the plurality of discs being concentrically connected to each other through the fastener; and
the second disc and the third disc being rotatably connected about the first disc.

2. The music theory learning device of claim 1, wherein the second disc is positioned opposite to the third disc across the first disc.

3. The music theory learning device of claim 1, wherein the third surface of the second disc along with the first surface of the first disc constitutes a ‘side 1’ of the device.

4. The music theory learning device of claim 1, wherein the fifth surface of the third disc along with the second surface of the first disc constitutes a ‘side 2’ of the device.

5. The music theory learning device of claim 1 comprising:
a central hole;
the central hole traversing concentrically through the plurality of discs;
and
the fastener being mounted within the central hole.

6. The music theory learning device of claim 1, wherein:
the first disc comprises a first radius;
the second disc comprises a second radius;
the third disc comprises a third radius;
the first radius is greater than the second radius;
the first radius is greater than the third radius; and
the second radius is equal to the third radius.

7. The music theory learning device of claim 1, comprising:
a first set of musical notations;
a second set of musical notations;
a first set of numbers;
a second set of numbers;
the first set of musical notations being perimetrically displayed on the first surface, adjacent to a first terminal edge of the first disc;
the second set of musical notations being perimetrically displayed on the second surface, adjacent to the first terminal edge of the first disc;
the first set of numbers being arranged radially on the third surface of the second disc, adjacent to a second terminal edge of the second disc; and
the second set of numbers being arranged radially on the fifth surface of the third disc, adjacent to a third terminal edge of the third disc.

8. The music theory learning device of claim 7, comprising:
a plurality of key signatures; and
the plurality of key signatures being distributed adjacent to the first set of musical notations and the second set of musical notations.

9. The music theory learning device of claim 7, comprising:
the first set of musical notations being laterally offset from the first set of numbers; and
each of the numbers from the first set of numbers being linearly aligned to each of the notations from the first set of musical notations.

10. The music theory learning device of claim 7, comprising:
the second set of musical notations being laterally offset from the second set of numbers; and
each of the numbers from the second set of numbers being linearly aligned to each of the notations from the second set of musical notations.

11. The music theory learning device of claim 1, comprising:
an instructional booklet; and
the instructional booklet comprises a plurality of formulas and tables.

12. The music theory learning device of claim 11, wherein each of the plurality of formulas and tables comprising at least one of chords, scales, intervals, modes, chord extensions, and chord symbols related to music.

13. The music theory learning device of claim 11, wherein the instructional booklet comprises a section on introduction to music theory.

14. The music theory learning device of claim 1, wherein the fastener is a rivet.

15. A music theory learning device comprising:
a plurality of discs;
at least one fastener;
an instructional booklet;
the plurality of discs comprising a first disc, a second disc, and a third disc;
the first disc comprising a first surface and a second surface wherein the first surface is positioned opposite to the second surface across the first disc;
the second disc comprising a third surface and a fourth surface, wherein the third surface is positioned opposite to the fourth surface across the second disc;
the third disc comprising a fifth surface and a sixth surface, wherein the fifth surface is positioned opposite to the sixth surface across the third disc;
the second disc being mounted adjacent to the first disc, wherein the fourth surface is oriented towards the first surface;
the third disc being mounted adjacent to the first disc, wherein the sixth surface is oriented towards the second surface;
the fastener being axially integrated between the plurality of discs;
the plurality of discs being concentrically connected to each other through the fastener;
the second disc and the third disc being rotatably connected about the first disc; and
the instructional booklet comprises a plurality of formulas and tables.

16. The music theory learning device of claim 15, wherein:
the third surface of the second disc along with the first surface of the first disc constitutes a ‘side 1’ of the device; and
the fifth surface of the third disc along with the second surface of the first disc constitutes a ‘side 2’ of the device.

17. The music theory learning device of claim 15, comprising:
a first set of musical notations;
a second set of musical notations;
a plurality of key signatures;
the first set of musical notations being perimetrically arranged and displayed on the first surface, adjacent to a first terminal edge of the first disc;
the second set of musical notations being perimetrically arranged and displayed on the second surface, adjacent to the first terminal edge of the first disc; and
the plurality of key signatures being distributed adjacent to the first set of musical notations and the second set of musical notations.

18. The music theory learning device of claim 15, comprising:
a first set of numbers;
the first set of numbers being arranged radially on the third surface of the second disc, adjacent to a second terminal edge of the second disc;
a second set of numbers; and
the second set of numbers being arranged radially on the fifth surface of the third disc, adjacent to a third terminal edge of the third disc.

19. The music theory learning device of claim 15, wherein each of the plurality of formulas and tables comprises at least one of chords, scales, intervals, modes, chord extensions, and chord symbols related to music.

20. The music theory learning device of claim 15, wherein the fastener is a rivet.
